(19) United States
(12) Patent Application Publication
(10) Pub. No.: US 2012/0185669 A1
(43) Pub. Date: Jul. 19, 2012

(54) PROGRAM INSPECTION METHOD AND NON-TRANSITORY, COMPUTER READABLE STORAGE MEDIUM STORING INSPECTION PROGRAM

(75) Inventor: Shinsuke TERANISHI, Kawasaki (JP)

(73) Assignee: Fujitsu Limited, Kawasaki (JP)

(21) Appl. No.: 13/329,798

(22) Filed: Dec. 19, 2011

(30) Foreign Application Priority Data
Jan. 17, 2011 (JP) 2011-006654

(51) Int. Cl. G06F 12/06

(52) U.S. Cl. 711/209; 711/E12.078

(57) ABSTRACT

A method has generating an access address information file from an access-destination address list including addresses of access destinations accessed by a program and access types indicating whether write access or read access is made to the individual addresses, generating a configuration-map constraint information file that includes the plurality of address ranges being included in a memory map that includes access attributes indicating whether read access or write access is permitted in the individual memory areas of the target apparatus, a page ID serving as identification information of the certain address range represented by the page and a constraint represented by an access attribute of the page, and inspecting, for each page ID, whether or not the access type for the page ID included in the access address information file contradicts the constraint represented by the access attribute for the page ID included in the configuration-map constraint information file.

### CROSS-REFERENCE TO RELATED APPLICATION

This application is based upon and claims the benefit of priority of the prior Japanese Patent Application No. 2011-006654, filed on Jan. 17, 2011, the entire contents of which are incorporated herein by reference.

### FIELD

The present art relates to program inspection methods and inspection programs for inspecting programs that run on computers.

### BACKGROUND

Hitherto, instruction-set simulators have been used for checking the behaviors of programs that are to be executed on an image processing apparatus (hereinafter, referred to as an “apparatus A”), such as a computer including a central processing unit (CPU). The instruction-set simulators perform instruction-level simulation of the behaviors of programs that are to be executed on the apparatus A. That is, the instruction-set simulators of the apparatus A simulate instruction execution operations of the apparatus A. Generally, the instruction-set simulators are developed together with the apparatus A when the apparatus A is developed.

With the instruction-set simulators, the behaviors of programs that are to be executed on the apparatus A can be inspected even if the apparatus A is not yet available. Accordingly, developers of the programs that are to run on the apparatus A execute the programs on the instruction-set simulators so as to check the behaviors of the programs until the apparatus A becomes available.

Meanwhile, during development of an information processing apparatus (hereinafter, referred to as an “apparatus B”) having configurations, such as a memory capacity or a memory map of an memory-mapped I/O, which are different from those of the apparatus A, developers may wish to check whether or not programs that run on the apparatus A will run on the apparatus B in the early stage of the development. For example, such a case corresponds to a case where developers create test programs of the apparatus B that is being developed by modifying test programs of the apparatus A. Since a vast number of test programs are often used for testing an information processing apparatus, the test programs of the apparatus B are also desirably developed in parallel to the development of the apparatus B.

However, in the initial stage of the development of the apparatus B, neither the apparatus B nor the instruction-set simulator of the apparatus B exists. In such a circumstance, the following operations are manually performed. First, differences between specifications of the apparatus A and specifications of the apparatus B are investigated on the basis of apparatus specification documents of the apparatuses A and B. Areas to be accessed by target programs are then analyzed on the basis of program specification documents, program design specification documents, source codes of the target programs, and so forth. On the basis of the result of the manual investigation and analysis, the developers determine whether or not modification of the target programs is needed in order to execute the target programs on the apparatus B.

Japanese Laid-open Patent Publication No. 06-236300 discloses a technique for detecting access violation caused by the behavior of a program in real apparatuses. This technique can be used when apparatuses that actually execute the program are available.

As described before, when developers investigate whether or not programs that run on the apparatus A will run on the apparatus B, the development of which is in the initial stage, techniques that use real apparatuses, such as the one disclosed in Japanese Laid-open Patent Publication No. 06-236300, are not applicable to apparatuses that are to be developed or produced. Accordingly, the investigation of differences between the specifications of the apparatuses A and B and the analysis of the behaviors of programs are performed manually, and lots of time is spent on this manual investigation and analysis. Additionally, additional time may be spent on analysis of errors of the programs because of imperfect investigations and mistakes in the analysis result.

There also are methods for inspecting whether or not programs can be executed on the apparatus B by developing the instruction-set simulator of the apparatus B until the apparatus B, which is being developed, is completed. However, in order to newly develop the instruction-set simulator of the apparatus B that is being developed, workers and time for developing the instruction-set simulator that is compliant with the specifications of the apparatus B are additionally needed. Furthermore, when a program for the apparatus A is executed on the instruction-set simulator of the apparatus B, the instruction-set simulator stops every time a part contradicting the specifications is executed, which makes it difficult to efficiently find out parts contradicting the specifications. Therefore, lots of time is spent on identification of the parts of the program that contradict the specifications, analysis of causes of the errors, and modification of the program.

Moreover, when there are many programs that the developers wish to check whether or not the programs will run on the apparatus B, it is much difficult to manually perform the check. For example, in the case that test programs of the apparatus B that is being developed are created by modifying test programs used for testing the apparatus A, lots of work and time are spent on manually checking parts of the test programs to be corrected if there are a vast number of test programs.

### SUMMARY

According to an aspect of an embodiment, A program inspection method for inspecting, by using a computer, whether or not a program that runs on an existing apparatus successfully runs on a target apparatus having a configuration that is different from a configuration of the existing apparatus, apparatus specifications of the target apparatus being already revealed, the program inspection method has generating an access address information file from an access-destination address list, the access-destination address list including addresses of access destinations accessed by the program and access types indicating whether write access or read access is made to the individual addresses by the program, the access address information file including, for each page representing a certain address range associated with the same access type, a page ID serving as identification information of the certain address range represented by the page and an access type of the page, generating a configuration-map constraint information file that includes, for each of the pages into which a plurality of address ranges of memory areas of the target apparatus are divided, the plurality of address ranges being included in a memory map that includes access attributes indicating whether read access or write access is permitted in the individual memory areas of the target apparatus, a page ID serving as identification information of the certain address range represented by the page and a constraint represented by an access attribute of the page, and inspecting, for each page ID, whether or not the access type for the page ID included in the access address information file contradicts the constraint represented by the access attribute for the page ID included in the configuration-map constraint information file.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 is a diagram illustrating a configuration for inspecting a program according to an embodiment.

FIG. 2 is a diagram illustrating an example of an image processing apparatus for performing a program inspection method according to an embodiment.

FIG. 3 is a diagram illustrating a flow of a program inspection process according to an embodiment illustrated in FIG. 1.

FIG. 4 is a diagram illustrating a process of determining page data.

FIGS. 5A and 5B are diagram illustrating a process of generating an access address information file.

FIG. 6 is a diagram illustrating a merging process in generation of an access address information file.

FIG. 7 is a diagram illustrating an example of an access address information file.

FIG. 8 is a diagram illustrating a process of generating a configuration-map constraint information file.

FIG. 9 is a diagram illustrating a process performed by a checking unit.

FIG. 10 is a diagram illustrating an example of a memory map specification of an existing apparatus.

FIG. 11 is a diagram illustrating an example of a program illustrated in FIG. 1.

FIGS. 12A to 12G are diagrams illustrating an example of a process of generating an access address information file.

FIGS. 13A and 13B are diagrams illustrating a process of creating an apparatus configuration map.

FIG. 14 is a diagram illustrating an example of page-access constraint information.

FIG. 15 is a diagram illustrating an example of a check process.

### DESCRIPTION OF EMBODIMENTS

Embodiments of the present invention will be described in detail below.

### First Embodiment

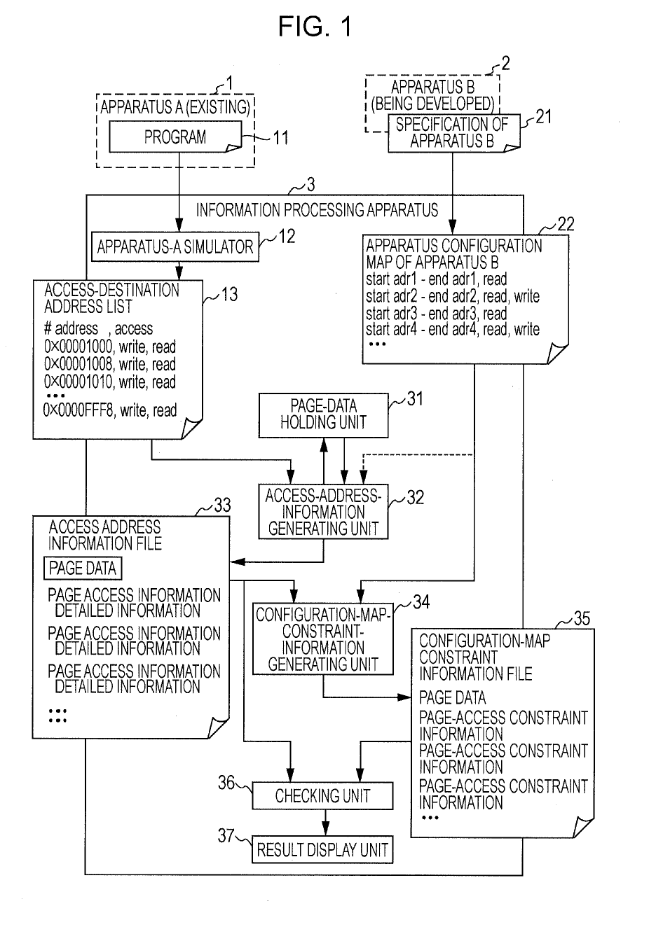

FIG. 1 is a diagram illustrating a configuration for inspecting a program according to an embodiment. Referring to FIG. 1, an apparatus 1 (hereinafter, referred to as an “apparatus A”) is an information processing apparatus, e.g., a server, a supercomputer, a microcomputer, or an application specific integrated circuit (ASIC). The apparatus A is an existing information processing apparatus which includes a central processing unit (CPU) and a storage device (not illustrated), such as a memory, and on which a program 11 can be executed. An apparatus 2 (hereinafter, referred to as an “apparatus B”) is an apparatus which is being developed and which has a memory map different from that of the apparatus A, for example.

In the course of development of the apparatus B, there may be a case that only a specification 21 of the apparatus B is present. In such a circumstance, a case will be discussed where a developer wishes to modify the program 11 created for the apparatus A so that the program 11 runs on the apparatus B. In this embodiment, whether or not the program 11 created for the apparatus A successfully runs on the apparatus B is checked by using a result of memory access that occurs when the program 11 is executed on a simulator of the apparatus A.

An apparatus 3 is an information processing apparatus, such as a general-purpose computer, which is different from the apparatuses A and B. The apparatus 3 is capable of executing an instruction-set simulator 12 of the apparatus A, and performs individual processes to be described below according to the embodiment.

When the apparatus A is present that serves as a reference of the apparatus B that is being developed, memory access to be made by the program 11 has to be compliant with the specification of the apparatus B in order to make the program 11 that run on the apparatus A run on the apparatus B. As described above, when methods for manually analyzing apparatus specification documents of the apparatuses A and B and a specification document of the program 11 are used, lots of time is spent on the analysis. Accordingly, in this embodiment, a method is provided in which memory access violation that would occur if the program 11 for the apparatus A were executed on the apparatus B is automatically detected by using the general-purpose information processing apparatus 3 instead of the manual program analysis.

In this embodiment, an access-destination address list 13, which contains results of memory access obtained when the program 11 created for the apparatus A is executed on the instruction-set simulator 12 of the apparatus A (hereinafter, referred to as an “apparatus-A simulator 12”), is creased by using the general-purpose information processing apparatus 3. The access-destination address list 13 includes information on a memory address of an access destination that has been accessed by that the program 11 and information on an access type that indicates read access, write access, or the like. Examples of the access type include “read”, “write”, and “write-read”.

Although the example of creating the access-destination address list 13 from the result simulated by the apparatus-A simulator 12 has been described in this embodiment, the access-destination address list 13 may be created without using the apparatus-A simulator 12. For example, the access-destination address list 13 may be created on the basis of a log of execution results obtained when the program 11 is executed on the apparatus A. Additionally, the information on memory addresses of access destinations of the program 11 and the information on access types may be obtained using methods, other than the apparatus-A simulator 12, whereby the access-destination address list 13 may be created.

An apparatus configuration map 22 of the apparatus B is also created from memory map information which represents a memory configuration defined in the apparatus specification 21 of the apparatus B. The apparatus configuration map 22 contains, for each address range included in the memory map of the apparatus B, information on an access attribute, such as “read permitted”, “write permitted”, or “read-write permitted”. More specifically, the apparatus configuration map 22 contains a start address, an end address, and an access attribute of each address range included in the memory map of the apparatus B.

At this point, it is possible to check whether or not memory access made by the program 11 violates the memory map specification of the apparatus B using the created access-destination address list 13 and apparatus configuration map 22. However, it is not efficient to check each of the access results of the program 11 that are recorded in the access-destination address list 13. Accordingly, in this embodiment, the access-destination address list 13 and the apparatus configuration map 22 are divided into certain address ranges, and occurrence of memory access violation is checked in units of certain address ranges.

More specifically, the access-destination address list 13 and the apparatus configuration map 22 are divided in units of pages, which correspond to the certain address ranges, whereby an access address information file 33 and a configuration-map constraint information file 35 are generated. The access address information file 33 is a file in which information on results of accesses made by the program 11 are divided and recorded in units of pages. The configuration-map constraint information file 35 is a file in which access attribute information for each address range contained in the apparatus configuration map 22 is divided and recorded in units of pages. By dividing the access-destination address list 13 and the apparatus configuration map 22 in units of pages, whether or not a program subjected to inspection will cause memory access violation can be inspected at high speed.

The generated access address information file 33 is then compared with the configuration-map constraint information file 35, and locations where memory access violation would occur if the program 11 were executed on the apparatus B are displayed. Details thereof will be described below.

The program 11 is a program that runs on the apparatus A. The apparatus-A simulator 12 is an instruction-set simulator that performs instruction-level simulation of operations of the apparatus A. The apparatus-A simulator 12 can be executed by a general-purpose computer, such as the information processing apparatus 3. The access-destination address list 13 is a list that contains information on memory addresses of address destinations accessed by the program 11 when the program 11 is executed on the apparatus-A simulator 12 and information on access types, such as read access or write access.

The specification 21 of the apparatus B is a specification document in which functional specifications of the apparatus B are written by using texts and drawings. The specification 21 is a material that is held as an electronic file on a recording medium, such as a compact disc-read only memory (CD-ROM), or is a material printed on paper.

The apparatus configuration map 22 represents the access attribute of each address range included in the memory map of the apparatus B. The apparatus configuration map 22 is created by a designer of the apparatus B or a person who is to modify the program 11 so that the program 11 becomes compatible with the apparatus B.

A page-data holding unit 31 holds range information (page data) which is used when an address range where access of the same type successively occurs among from the access results recorded in the access-destination address list 13 is divided into specific ranges (pages).

An access-address-information generating unit 32 generates the access address information file 33 by dividing and organizing the information on the access results, which are contained in the access-destination address list 13 and which are obtained by using the apparatus-A simulator 12, in units of page data held by the page-data holding unit 31. The access address information file 33 serves as reference data used for debugging whether or not the program 11 runs on the apparatus B.

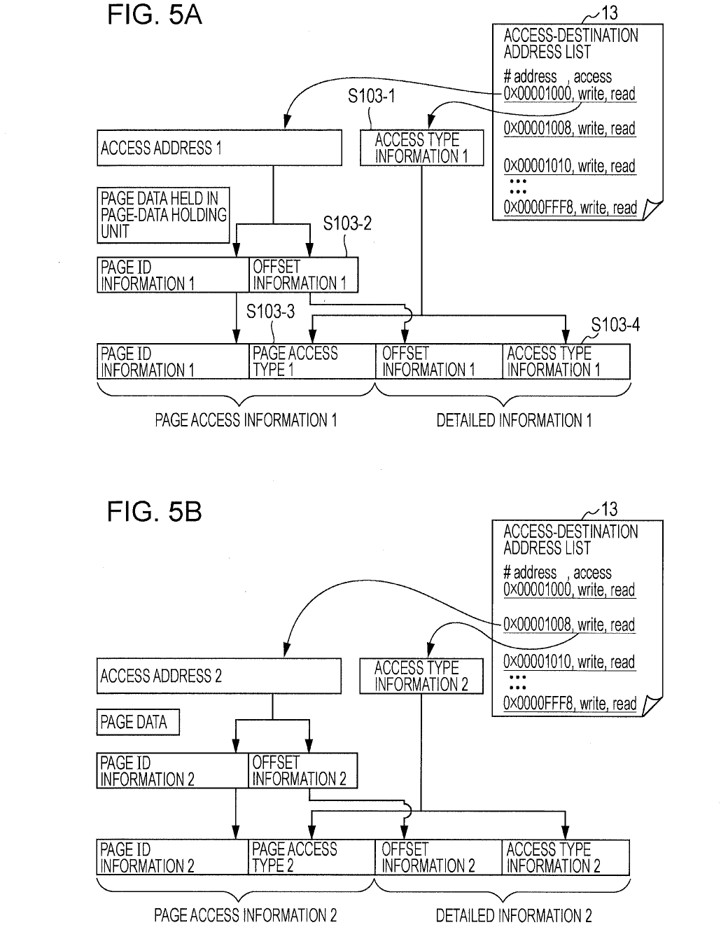

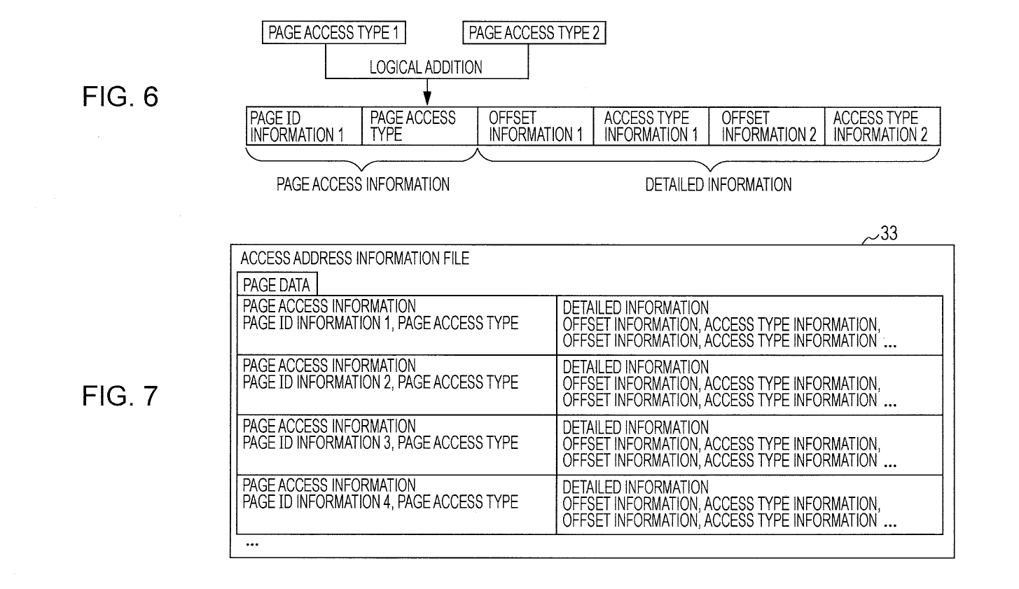

The access address information file 33 includes a program name of a program subjected to inspection, page data, page ID information, detailed information such as address offset information, and access type information. Here, the page data is range information that represents a certain address range (page) for use in dividing an address range where access of the same type successively occurs among from the access results recorded in the access-destination address list 13. That is, the page data is information used for dividing the access-destination address list 13 into the certain address ranges and assigning an ID to each of the divided address ranges to discriminate the address ranges from one another. Details of a method for generating the page ID information and the detailed information will be described later using FIGS. 5A to 6. The program name and the page data may be excluded from the information that is recorded in the access address information file 33. In such a case, the page data may be referred directly to the page-data holding unit 31 by following processes in which the page data is referred to.

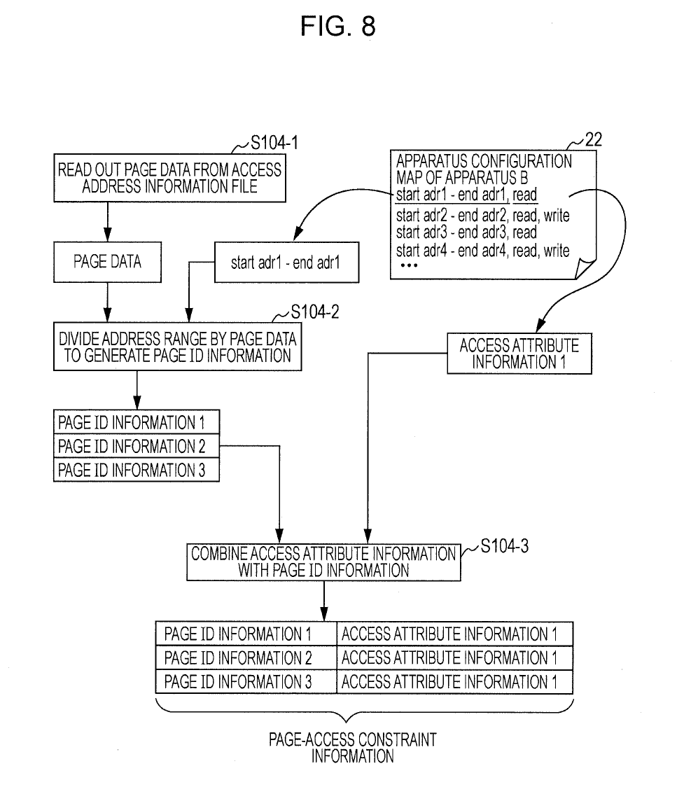

A configuration-map-constraint-information generating unit 34 divides access constraints of memory areas contained in the apparatus configuration map 22 by the page data, thereby generating the configuration-map constraint information file 35. Details of the method for generating the configuration-map constraint information file 35 will be described later using FIG. 8.

A checking unit 36 checks locations of the program where access violation would occur if the program 11 were executed on the apparatus B. More specifically, the checking unit 36 checks whether or not access violation would occur if the program 11 were executed on the apparatus B, on the basis of the access address information file 33 and the configuration-map constraint information file 35.

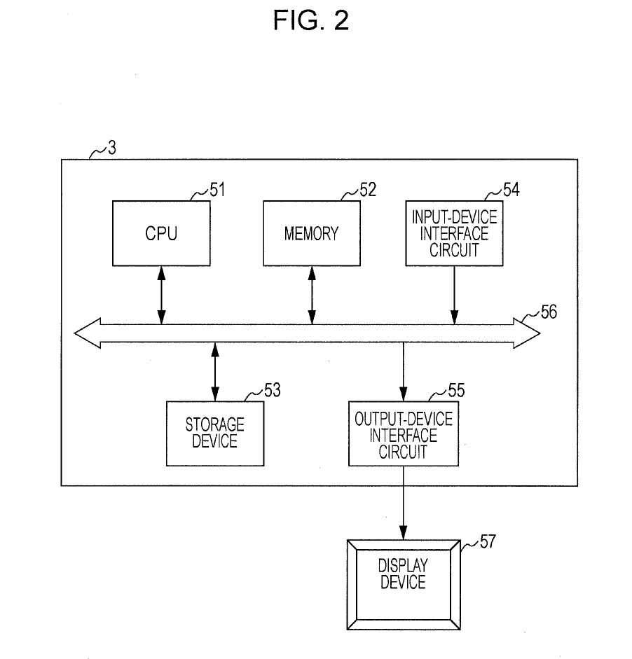

A result display unit 37 displays results of the check performed by the checking unit 36 on a display device, such as a display (not illustrated). FIG. 2 is a diagram illustrating an example of a hardware configuration of the image processing apparatus 3, such as a computer, for performing the program inspection method according to the embodiment. The information processing apparatus 3 includes a central processing unit (CPU) 51, a memory 52, a storage device 53, an input-device interface circuit 54 serving as an interface to input devices, such as a keyboard and a mouse, and an output-device interface circuit 55 serving as an interface to output devices, such as a display device 57.

The storage device 53 includes a magnetic disk device, an optical disc device, a magneto-optical disk device, or a semiconductor storage device and includes a drive device that handles a computer-readable recording medium. As the recording medium handled by the drive device, a computer-readable recording medium of any type, such as a magnetic tape, a memory card, an optical disc (such as a CD-ROM or DVD-ROM), or a magneto-optical disk (such as an MO or MD) may be used.

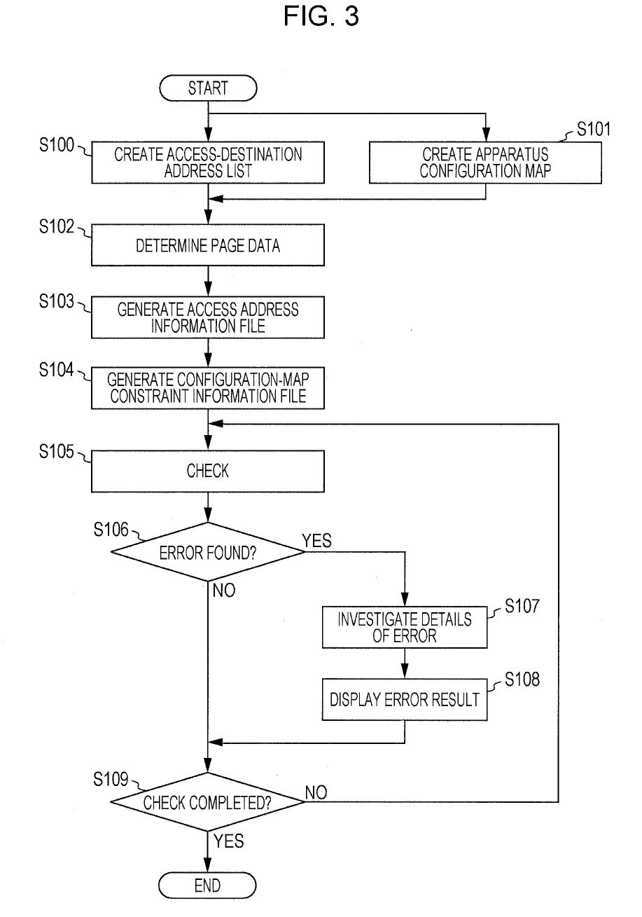

The storage device 53 stores programs for performing individual processes according to an embodiment and the various files 13, 22, 33, and 35 that are used in the embodiment. The CPU 51 accesses the memory 52, the storage device 53, various input/output devices, and so forth via a bus 56 and the interface circuits 54 and 55, and executes the various processing programs stored in the storage device 53 or the various processing programs loaded into the memory 52 or the like. Various processes to be described in the embodiment are executed by the CPU 51 of the information processing apparatus 3 illustrated in FIG. 2. FIG. 3 is a diagram illustrating a flow of a program inspection process according to an embodiment illustrated in FIG. 1.

First, in S100, the access-destination address list 13 is created. As illustrated in FIG. 1, the access-destination address list is a list that contains information on addresses of access destinations and information on the access type, such as read or write, of each address that are based on access results of the program 11. Although there are some methods for creating the access-destination address list 13 as described above, the description will be given here for the method for creating the access-destination address list 13 by using the apparatus-A simulator 12, for example.

The program 11 developed for the apparatus A is executed by the apparatus-A simulator 12 that simulates instruction execution operations of the apparatus A. At this time, the apparatus-A simulator 12 outputs memory addresses of access destinations that have been accessed by the program 11 and the access type that indicates read access or write access, to the access-destination address list 13. The program 11 can be executed by the apparatus-A simulator 12, i.e., by the general-purpose information processing apparatus 3 capable of executing the apparatus-A simulator 12.

Information on access results obtained when the program 11 is executed by the apparatus-A simulator 12 is chronologically outputted to a file, whereby the access-destination address list 13 can be created. When the access results of the accesses made by the program 11 are chronologically outputted, a single address may be repeatedly accessed many times. It becomes easier to determine whether or not access of the same type successively occurs, i.e., whether or not the types of accesses that have been made to successive addresses are the same, if the information on the access results is organized in accordance with a certain procedure.

More specifically, for example, the results of accesses made by the program 11 are sorted by the address and overlapping information is deleted. If both read access and write access are made to a single address among from the results of the accesses made by the program 11, the access types are merged into “write-read”. These processes can be executed by editing the execution result of the apparatus-A simulator 12 using a processing program written with a program language for processing text files, for example. Accordingly, a result obtained by sorting the information on the access destinations chronologically output by the apparatus-A simulator 12 in the ascending or descending order of the address, by deleting overlapping information, and merging the types of the accesses made to a single address may be used as the access-destination address list 13.

In S101, the apparatus configuration map 22 which is a memory map of the apparatus B is created besides creation of the access-destination address list (S100). A worker who is to create the apparatus configuration map 22, i.e., a designer of the apparatus B or a person who is to execute the program 11 on the apparatus B, creates the apparatus configuration map 22 on the basis of the memory map specification written in the specification 21 of the apparatus B.

As illustrated in FIG. 1, the apparatus configuration map 22 is a file that contains a start address (start adr), an end address (end adr), and an access attribute of each memory area defined in the memory map written in the specification 21 of the apparatus B. Here, the access attribute indicates whether read, write, or both read and write are permitted in a specific memory area.

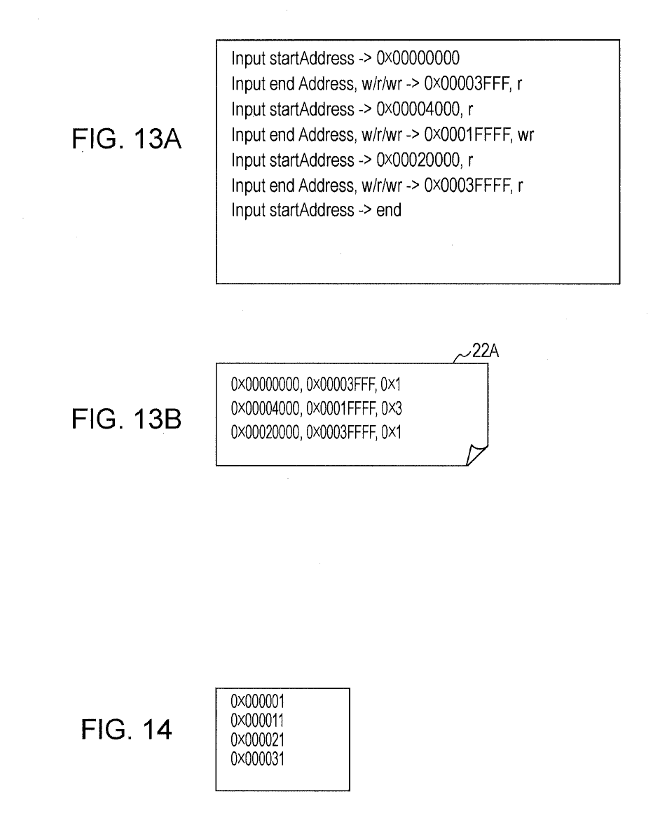

A worker may manually input information to the file of the apparatus configuration map 22 so as to create the apparatus configuration map 22 or may use some kind of assistant tool (program) for generating the file of the apparatus configuration map 22 so as to create the apparatus configuration map 22. Generation of the file of the apparatus configuration map 22 using the assistant tool will be described later using FIGS. 13A and 13B.

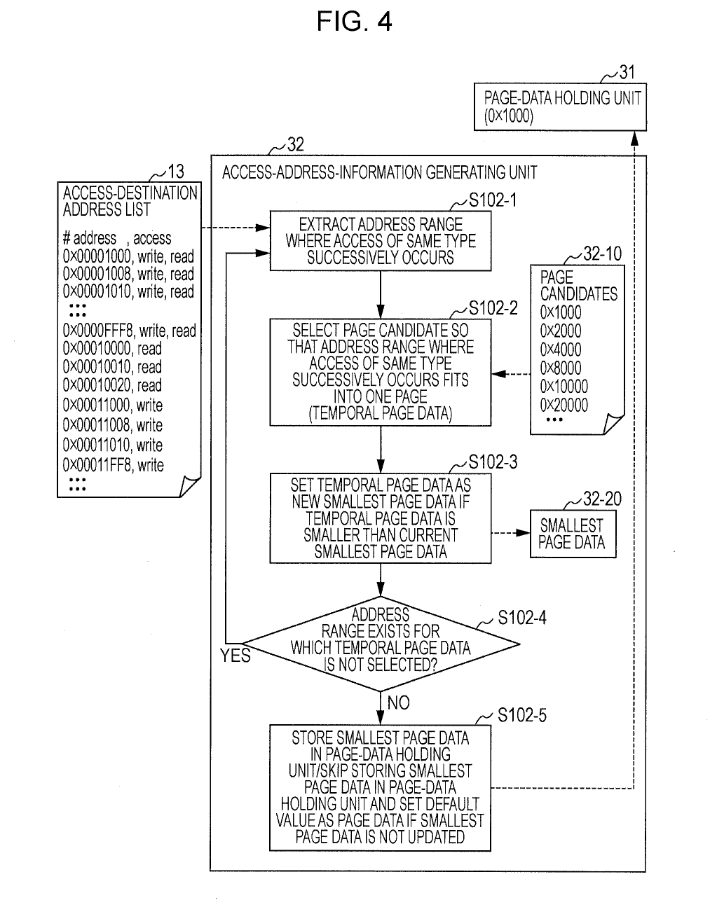

In S102, the access-address-information generating unit 32 determines page data. The page data is range information that represents the size of a specific range (page) used when an address range, where access of the same type successively occurs, recorded in the access-destination address list 13, is divided. Processing is performed in S103 and the following steps of FIG. 3 using the page data determined in S102 as common page data. Details of a procedure of determining the page data will be described later using FIG. 4.

In S103, the access-address-information generating unit 32 divides and organizes the information on the access destinations of the program 11 recorded in the access-destination address list 13 in units of page data, thereby generating the access address information file 33. The access address information file 33 is a file in which information indicating the access types of accesses successively made to an address range recorded in the access-destination address list 13 is grouped for each range (page) indicated by the page data. As illustrated in FIG. 1, the access address information file 33 includes, for each page, page access information and detailed information. Details of the procedure of generating the access address information file 33 will be described later using FIGS. 5A and 5B.

In S104, the configuration-map-constraint-information generating unit 34 generates the configuration-map constraint information file 35. The configuration-map constraint information file 35 is a file in which access constraints of each memory area contained in the apparatus configuration map 22 are divided by the page data. The configuration-map-constraint-information generating unit 34 reads out the page data from the access address information file 33 or the page-data holding unit 31, and generates the configuration-map constraint information file 35 in which the memory map information of the apparatus configuration map 22 that has been created in S101 is divided by the address range indicated by the page data. Details of the procedure of generating the configuration-map constraint information file 35 will be described later using FIG. 8.

In a check process performed in S105, the checking unit 36 checks locations of the program 11 where access violation would occur if the program 11 were executed in the apparatus B, using the access address information file 33 that has been generated in S103 and the configuration-map constraint information file 35 that has been generated in S104. More specifically, if the checking unit 36 checks, for each page, whether or not the access type read out from the access address information file 33 contradicts the corresponding access attribute read out form the configuration-map constraint information file 35. If the result of the check performed in S105 indicates an error, i.e., if access violation is found (YES in S106), the checking unit 36 investigates details of the access violation (S107). The result display unit 37 displays the error result (S108). If the result of the check performed in S105 does not indicate an error (NO in S106), the process proceeds to S109.

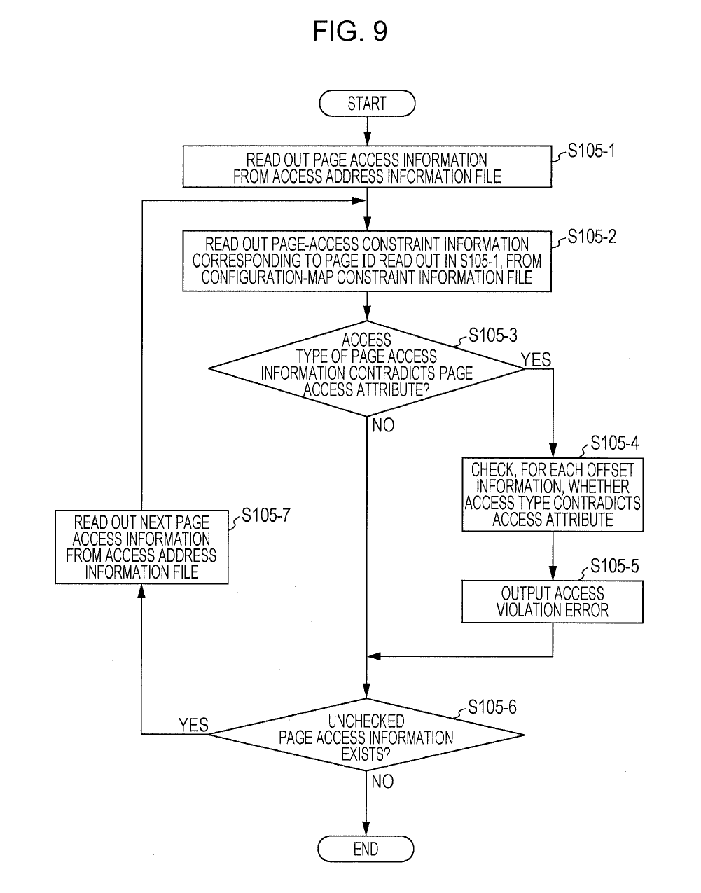

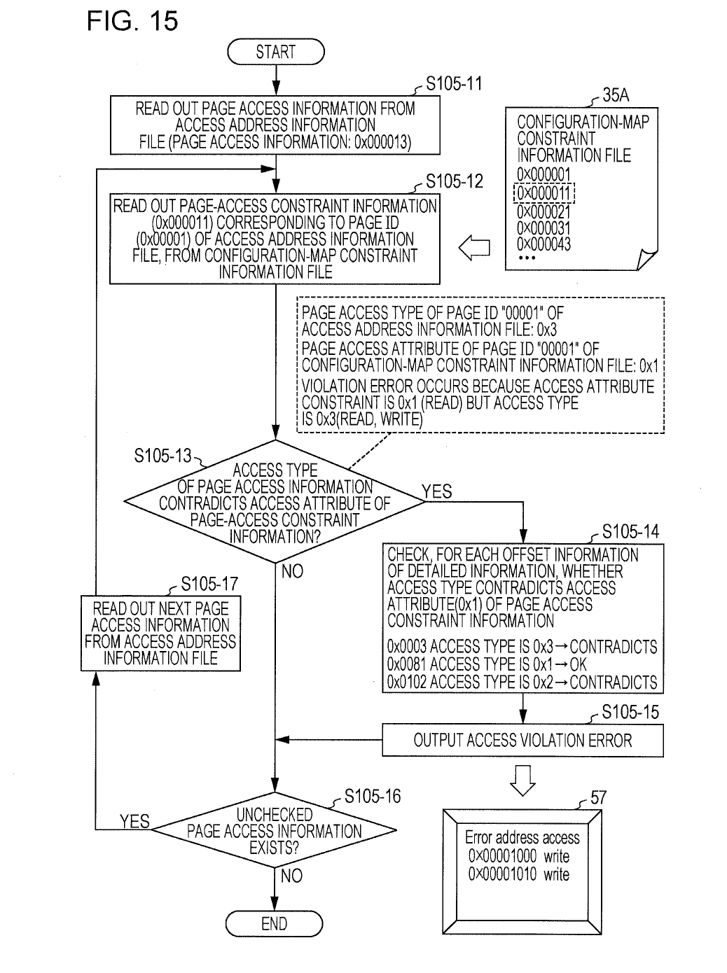

In S109, whether or not the check has been completed for all ranges of the page data recorded in the access address information file 33. If the check has not been completed for all ranges of the page data recorded in the access address information file 33 (NO in S109), the process returns to S105 and the check is similarly performed on one of the unchecked ranges of the page data. If the check has been completed for the all ranges of the page data recorded in the access address information file 33 (YES in S109), the process ends. Details of the check process performed in S105 to S109 will be described later using FIGS. 9 and 15. Details of each process illustrated in FIG. 3 will be described below.

FIG. 4 is a diagram illustrating the process of determining the page data. The page-data holding unit 31 holds a predetermined value as an initial value of the page data. In the example of FIG. 4, the initial value of the page data is “0x1000”. For example, the smallest value of values of page candidates, which will be described later, may be set as the initial value of the page data.

Prior to generation of the access address information file 33, the access-address-information generating unit 32 determines the page data. The access-address-information generating unit 32 sets the smallest address range of address ranges where access of the same access type successively occurs among from the access addresses and the access types recorded in the access-destination address list 13. At this time, for example, the access-address-information generating unit 32 can prepare page candidates 32-10 that serve as candidates of the page data and select one of the page candidates in accordance with the size of the address range where access of the same type successively occurs.

The page candidates 32-10 that serve as candidates of the page data can be determined by predicting some address-range candidates that are likely to be used as units for dividing a memory address area, from the memory map specifications of the existing apparatus A and the apparatus B that is being developed. At this time, values with which each address range included in the apparatus configuration map 22 can be divided without the remainder are desirably predicted as the page candidates 32-10 in order to avoid a situation in which address ranges having different access attributes are divided into the same page when the address ranges included in the apparatus configuration map 22 of the apparatus B are divided by the page data in generation of the configuration-map constraint information file 35 which will be described below. When details, such as specifications of control registers of the apparatus B, have not been decided, an area having different access attributes, such as the control registers, may be collectively treated as a read-write-permitted area.

The process of determining the page data will be described on the basis of the flowchart of FIG. 4. First, one series of addresses where access of the same type successively occurs is selected, and the selected series of addresses is read out (S102-1). An address range, by using which the access-destination address list 13 can be divided into predetermined address ranges (pages) so that the read out series of addresses are contained in one page, is selected from the page candidates 32-10. At this time, the smallest page candidate of the selectable page candidates is set as the page data for the read out series of addresses (S102-2). Hereinafter, the page data selected from the page candidates 32-10 for each read out series of addresses is referred to as “temporal page data”. Additionally, the smallest value of the pieces of temporal page data is referred to as “smallest page data”.

The smallest value of the pieces of temporal page data is stored as the smallest page data 32-20. More specifically, after the temporal page data for each series of addresses is selected and determined from the page candidates 32-10. The determined temporal page data is compared with the smallest page data 32-20 to determine whether or not the temporal page data is smaller than the smallest page data 32-20. If the determined temporal page data is smaller than the smallest page data 32-20, the smallest page data 32-20 is overwritten by the value of the temporal page data (S102-3). Meanwhile, for example, the largest value of the page candidates 32-10 may be set as an initial value of the smallest page data 32-20.

If no page candidate that is suitable for the series of addresses read out in S102-1 is found in selection of the temporal page data from the page candidates 32-10, the selection of the temporal page data and the update of the smallest page data are skipped and the process proceeds to S102-4. For example, regarding the example of the page candidates 32-10 illustrated in FIG. 4, when a difference between the largest value and the smallest value of the series of addresses read out in S102-1 is larger than “0x20000”, the process proceeds to S102-4 without selecting the temporal page data and updating the smallest page data.

After the processing in S102-3, the process proceeds to S102-4. In S102-4, whether or not an address range for which the temporal page data has not been selected exists in the access-destination address list 13 is determined. If an address range for which the temporal page data has not been selected exists in the access-destination address list 13 (YES in S102-4), the process returns to S102-1. The next series of addresses is read out and the temporal page data is selected (S102-2).

If the temporal page data has already selected for all address ranges included in the access-destination address list 13 (NO in S102-4), the smallest page data 32-20 is stored in the page-data holding unit 31 (S102-5). When the smallest page data is never updated, storage of the smallest page data 32-20 in the page-data holding unit 31 is skipped and the initial value stored in the page-data holding unit 31 is used as the page data.

As described before, the page data is desirably determined in consideration of information included in the apparatus configuration map 22 that has been created on the basis of the specification 21 of the apparatus B. That is, a value with which each address range contained in the apparatus configuration map 22 can be equally divided into ranges having the same size is desirably set as the page data. For example, as indicated by a broken-line arrow in FIG. 1, the access-address-information generating unit 32 may refer to information of the apparatus configuration map 22, such as the start address of each address range. The access-address-information generating unit 32 checks whether or not the start address of each address range contained in the apparatus configuration map 22 can be divided by the determined page data without the remainder, thereby checking whether or not each address range can be equally divided into ranges having the same size. If each address range contained in the memory map of the apparatus B is not equally divisible into ranges having the same size by the determined page data, it is determined that the address range contained in the apparatus configuration map 22 is not divisible by the determined page data so that different access attributes do not coexist. Accordingly, the value of the page data can be modified in the early stage by taking the information included in the apparatus configuration map 22 into account when the page data is determined.

Meanwhile, there may be a case where a worker grasps the appropriate value of the page data on the basis of the specification of the program 11 and the memory map specification of the apparatus configuration map 22. In such a case, the series of processing steps described in FIG. 4 may be omitted and the worker may in advance store the desirable value of the page data in the page-data holding unit 31.

For example, “0x1” may be stored in advance as the page data. In this case, a page ID is assigned to each address and, thus, access violation can be checked for each address. However, in terms of processing speed of and an amount of memory to be used in the check process performed by the checking unit 36, an address range having a certain size may be desirably set as the page data. FIGS. 5A and 5B are diagrams illustrating the process of generating the access address information file 33. The process of generating the access address information file 33 to be described below is performed by the access-address-information generating unit 32.

First, a pair of address information and access type information is read out from the access-destination address list 13 illustrated in FIG. 5A. Referring to FIG. 5A, a first data pair is read out from the access-destination address list 13. The read out address information is set as an “access address 1”, whereas the read out access type information is set as “access type information 1” (S103-1). The page data stored in the page-data holding unit 31 is then read out. The quotient obtained by dividing the access address 1 by the value of the page data is set as “page ID information 1”, whereas the remainder obtained by the division is set as “offset information 1” (S103-2).

Here, the page ID information is composed of the most significant bits of the access address and serves as identification information for identifying each divided address range which is obtained by dividing a plurality of pieces of address information included in the access-destination address list 13 by the page data. The offset information is composed of the least significant bits of the access address and serves as an offset address that indicates an address in each divided address range (page). The access type information indicates whether the type of the access is read or write, and is represented by, for example, 2-bit binary value.

For example, the access type is represented in a format of {“write”, “read”}. The access types “read”, “write”, and “write-read” are denoted as “01” (0x1), “10” (0x2), “11” (0x3), respectively (the values enclosed by brackets indicate hexadecimal notation of the binary values). The access type information is association with each page ID information and each offset information.

The page ID information 1 is combined with the access type information 1, whereby the page access information is generated (S103-3). The access type information 1 that is combined with the page ID information in the page access information 1 is referred to as a page access type 1. Further, the offset information 1 is combined with the access type information 1, whereby detailed information 1 is generated (S103-4). In this way, one piece of access address information which includes the page access information 1 and the detailed information 1 is generated.

FIG. 5B illustrates the process of generating page access information 2 and detailed information 2 using the same procedure as that illustrated in FIG. 5A, by reading out a second data pair included in the access-destination address list 13. Thereafter, the access address information and the access type information are sequentially read out from the address-destination address list 13, and the page access information and the detailed information are generated in the same manner. FIG. 6 is a diagram illustrating a process of merging pieces of information for a single page assigned the same page ID in generation of the access address information file. As illustrated in FIGS. 5A and 5B, when a data pair is sequentially read out from the access-destination address list 13 and the page access information is generated, there may be a case where the page ID information included in the page access information matches the page ID information that has been already generated. For example, when page ID information 2 calculated from an access address 2 matches the page ID information 1 that has been already generated, page access type 2 calculated from the access address 2 is merged with the page access type 1 for the page ID information 1 instead of newly generating the page access information 2.

More specifically, as illustrated in FIG. 6, information resulting from logical addition of the page access type 1 for the page ID information 1 and the page access type 2 for the access address 2 is set as the new page access type 1. Here, “logical addition” indicates a calculation in which, for example, when the page access type 1 is write (“10”) and the page access type 2 is read (“01”), “write-read” (“11”) is obtained as a result of the logical addition. Thereafter, the detailed information 2 which includes the offset information 2 generated from the access address 2 and the access type information 2 is appended to the detailed information 1.

The similar process is performed on data that is sequentially read out from the access-destination address list 13. After the processes described in FIGS. 5A to 6 have been completed for all pairs of address information and access type information included in the access-destination address list 13, extraction of data needed for generation of the access address information file 33 ends. FIG. 7 is a diagram illustrating an example of the access address information file. After the extraction of data needed for generation of the access address information file 33 ends in accordance with the processes described in FIGS. 5A to 6, the access-address-information generating unit 32 writes out the extracted data as the access address information file 33 as illustrated in FIG. 7.

At this time, the access-address-information generating unit 32 reads out the page data stored in the page-data holding unit 31, and writes the page data in the access address information file 33. In the example illustrated in FIG. 7, the page data is written at the first part of the access address information file 33 but the page data may be written at the last part of the access address information file 33. In addition, writing of the page data in the access address information file 33 may be omitted and the page data may be referred directly to the page-data holding unit 31 in processes described below.

Every time individual page access information and individual detailed information are generated in the processes illustrated in FIGS. 5A to 6, the generated page access information and detailed information may be written in the access address information file 33. Alternatively, the individual page access information and the individual detailed information that have been generated in the processes illustrated in FIGS. 5A to 6 may be temporarily stored in a memory or the like, and the temporarily-stored page access information and detailed information may be collectively written out in the access address information file 33 at the last. FIG. 8 is a diagram illustrating the process of generating the configuration-map constraint information file 35. First, the configuration-map-constraint-information generating unit 34 reads out the page data from the access address information file 33 (S104-1).

The configuration-map-constraint-information generating unit 34 then reads out the first address range (start adr1-end adr1) from the apparatus configuration map 22, and divides the read out address range by the page data. The configuration-map-constraint-information generating unit 34 divides start addresses of the resulting address ranges by the page data, and generates page ID information by using the quotients of the division as the page IDs (S104-2). In the example illustrated in FIG. 8, the first address range (start adr1-end adr 1) is divided by the page data into three address ranges, and three pieces of page ID information 1 to 3 are generated. Meanwhile, the value of the page data is desirably set so that no remainder exists when the start address of each address range contained in the apparatus configuration map 22 is divided by the page data.

The configuration-map-constraint-information generating unit 34 combines each of the generated pieces of page ID information 1 to 3 with access attribute information 1 for the first address range read out from the apparatus configuration map 22, thereby generating page-access constraint information (S104-3).

Thereafter, the configuration-map-constraint-information generating unit 34 sequentially reads out the address ranges and the corresponding access attributes from the apparatus configuration map 22, and generates the page-access constraint information in the same manner. A collection of the pieces of page-access constraint information for all address ranges included in the apparatus configuration map 22 corresponds to the configuration-map constraint information file 35. FIG. 9 is a diagram illustrating the process performed by the checking unit 36. The checking unit 36 checks whether or not access violation would occur if the program 11 were executed on the apparatus B, on the basis of the access address information file 33 and the configuration-map constraint information file 35.

More specifically, the checking unit 36 first reads out the page access information, i.e., the page ID information and the page access type, from the access address information file 33 (S105-1). The checking unit 36 then reads out the page-access constraint information that corresponds to the page ID information read out from the access address information file 33, from the configuration-map constraint information file 35 (S105-2). At this time, the checking unit 36 may read out the access attribute information included in the page-access constraint information from the configuration-map constraint information file 35.

The checking unit 36 checks whether or not the access type read out from the access address information file 33 contradicts the access attribute read out from the configuration-map constraint information file 35 (S105-3). A concrete method for checking whether or not the access type contradicts the access attribute will be described later.

If access violation is not found as a result of the check performed in S105-3 (NO in S105-3), the process proceeds to S105-6 and the checking unit 36 determines whether or not unchecked page access information exists. If the unchecked page access information exists (YES in S105-6), the checking unit 36 reads out the next page access information from the access address information file 33 (S105-7). The process then returns to S105-2 and the check is performed in the same manner.

If access violation is found as a result of the check performed in S105-3 (YES in S105-3), the checking unit 36 reads out the detailed information associated with the page access information from the access address information file 33. The checking unit 36 then checks, for each offset information included in the read out detailed information, whether or not the access type for the offset information contradicts the access attribute read out from the configuration-map constraint information file 35 (S105-4).

The checking unit 36 outputs, an error result, the offset information and the access type information for which access violation is detected in the check performed in S105-4 (S105-5). At this time, the error result may be displayed on an output device, such as the display device 57, and a log of the error result may be outputted. Additionally, other information processing apparatuses may be informed of the error result via a communication network. The process then proceeds to S105-6.

If it is determined that the unchecked page access information does not exist in S105-6 (NO in S105-6), the checking unit 36 terminates the check process. In the above-described method for inspecting whether or not a program that runs on the existing apparatus A successfully runs on the apparatus B that is being developed, access information of the program is extracted from a result of executing the program on the existing apparatus A, and the extracted access information is compared with constraint information extracted from the specifications of the apparatus B. More specifically, the program is executed by a simulator of the apparatus A, and the access-destination address list 13 is generated. The access address information file 33 is generated by using the generated access-destination address list 13 and the page data. The configuration-map constraint information file 35 is also generated by using the page data and the apparatus configuration map 22 created on the basis of the specification 21 of the apparatus B. Information included in the generated access address information file 33 is compared with corresponding information included in the configuration-map constraint information file 35 for each page ID, whereby whether or not access violation would occur if the program were executed on the apparatus B is checked.

Accordingly, memory access violation caused by a program to be executed on the apparatus B can be detected using a simple and efficient method in a short time in a situation where an instruction-set simulator of the apparatus B, which is being developed, is not yet available. As a result, an amount of program modification for making the program that runs on the apparatus A run on the apparatus B can be estimated in the early stage of the development and examination of the apparatus B. Additionally, as described above, since neither the apparatus B nor the simulator of the apparatus B is needed for detecting memory access violation, the program can be inspected using a small number of resources such as a general-purpose personal computer.

The embodiment of the present art can be used for inspecting whether or not a general-purpose program that runs on the existing apparatus A runs on the apparatus B that is being developed, and also for creating a test program used in development of the apparatus B, for example. In particular, in the performance test of an information processing apparatus, such as a server, a vast number of test programs are created in order to inspect the performance. When a developer creates test programs of the apparatus B that is being developed by modifying test programs of the existing apparatus A, many test programs can be inspected in a short time by using the above-described program inspection method. Additionally, for example, when a developer wishes to create a test program that is expected to cause access violation, whether or not access violation occurs as expected can be checked in a short time. Accordingly, locations of the program to be modified can be identified and an amount of the modification can be estimated in the early stage of development of the apparatus B.

### Second Embodiment

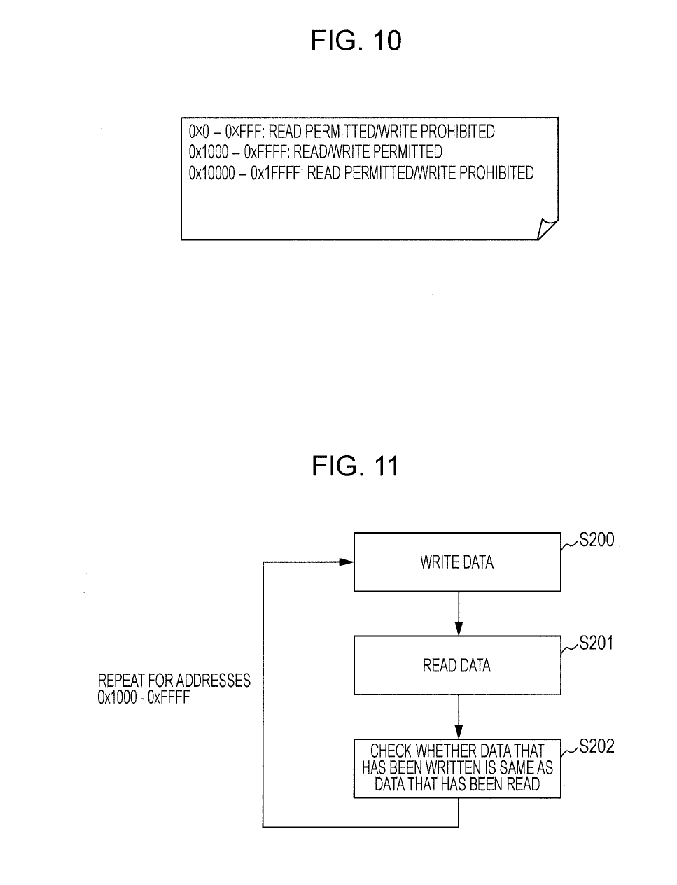

An example in which a program is inspected before a test program of the apparatus A is modified into a test program of the apparatus B that is being developed will be described by using a concrete example according to a second embodiment. FIG. 10 is a diagram illustrating an example of a memory map specification of the existing apparatus A. The apparatus A has, for example, the memory map specification illustrated in FIG. 10. More specifically, “read” is permitted but “write” is prohibited from “0x0” to “0xFFF”, “read” and “write” are permitted from “0x1000” to “0xFFFF”, and “read” is permitted but “write” is prohibited from 0x10000 to 0x1FFFF.

First, a process of generating an access address information file will be described.

FIG. 11 is a diagram illustrating, as an example of the program 11 illustrated in FIG. 1, a test program for testing memory access in the apparatus A. This test program is created so as to run on the apparatus A and is used for testing whether or not a memory of the apparatus A can be successfully accessed, for example. As illustrated in FIG. 11, the test program performs data write (S200) and data read (S201) on addresses from “0x1000” to “0xFFFF” to check whether or not the written data is correctly read (S202).

The apparatus-A simulator 12 simulates operations of the apparatus A at the machine instruction level, and runs on the OS (Operating System) of the information processing apparatus 3, which is a general-purpose computer. The apparatus-A simulator 12 simulates operations of the apparatus A that executes the program, while interpreting instructions of the test program. Every time the apparatus-A simulator 12 accesses a memory during simulation of the behaviors of the test program, the apparatus-A simulator 12 writes out an access address that is a memory address of an access destination and an access type, such as read or write, in a file of an access-destination address list. If the test program illustrated in FIG. 11 is executed on the apparatus-A simulator 12, address information of access destinations accessed by the test program and access type information, such as read or write, are written out as the access-destination address list 13. More specifically, address information of access destinations accessed when data write (S200) and data read (S201) are performed on the addresses from “0x1000” to “0xFFFF” and access type information of the accesses are written out as the access-destination address list 13.

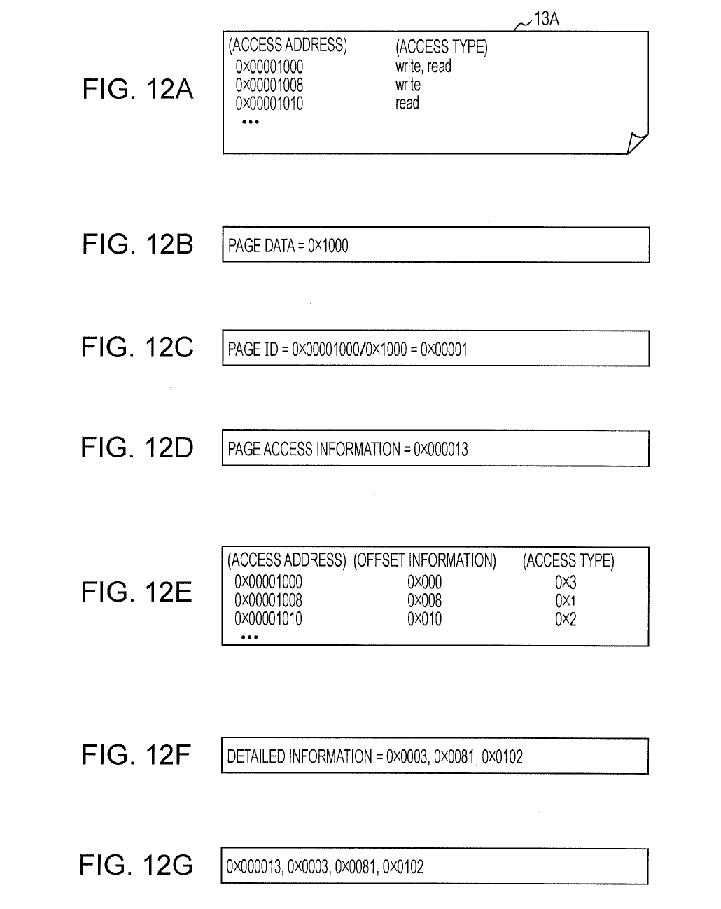

The access-address-information generating unit 32 generates the access address information file 33 on the basis of the access-destination address list 13 written out by the apparatus-A simulator 12. As illustrated in FIG. 7, the access address information file 33 includes the page data used for dividing the access-destination address list 13 into certain address ranges, page access information and detailed information that are obtained by dividing the access-destination address list 13 using the page data. For convenience of processing, the access types included in the page access information and the detailed information of the access address information file 33 are desirably converted into numerical values. The process of generating the access address information file illustrated in FIGS. 5A to 6 will be described by using a concrete example illustrated in FIGS. 12A to 12G. FIGS. 12A to 12G are diagrams illustrating an example of the process of generating the access address information file.

FIG. 12A is a diagram illustrating an example of the access-destination address list. FIG. 12B is a diagram illustrating an example of the page data. Regarding the examples illustrated in FIGS. 12A and 12B, a quotient obtained by dividing each access address by the page data “0x1000” serves as a page ID. Accordingly, the page ID for three access addresses “0x00001000”, “0x00001008”, and “0x00001010” illustrated in FIG. 12A is “0x00001” as illustrated in FIG. 12C.

In order to convert the access types into numerical values, “read” is denoted as 0x1 (“01”) and “write” is denoted as 0x2 (“10”) (the values enclosed by brackets indicate binary notation). In this case, the access type “write, read” is determined by performing logical addition of “read (“01”)” and “write (“10”)” and is denoted as “11” in binary notation, i.e., “0x3” in hexadecimal notation.

Since the page IDs of the three access addresses illustrated in the example of FIG. 12A are the same, i.e., “0x00001”, the page access type is determined to be “0x3 (“11”)” by performing logical addition of the three access types using the method illustrated in FIG. 6.

As illustrated in FIGS. 5A to 6, the page access information is obtained by appending the page access type (“0x3”) to the page ID “0x00001”. Accordingly, the page access information for the three access addresses illustrated in FIG. 12A is denoted as “0x000013” as illustrated in FIG. 12D.

As illustrated in FIGS. 5A to 6, detailed information includes offset information and access type information. As described above, the offset information corresponds to a remainder of dividing the access address by the page data. Accordingly, each access address, the offset information for the corresponding access address, and the access type for the corresponding access address in the examples illustrated in FIGS. 12A and 12B are written as illustrated in FIG. 12E.

As illustrated in FIGS. 5A to 6, the detailed information is a combination of the offset information and the access type information for the offset information. Accordingly, the detailed information for the example illustrated in FIG. 12E is denoted as “0x0003, 0x0081, 0x0102” as illustrated in FIG. 12F. In this case, the page access information and the detailed information of the access address information file 33 for the examples illustrated in FIGS. 12A and 12B are denoted as “0x000013, 0x0003, 0x0081, 0x0102” as illustrated in FIG. 12G.

The access address information file 33 is generated by processing all access results included in the access-destination address list 13A in accordance with the procedure described in FIGS. 12A to 12G so that each access result is assigned a page ID and by adding the page data. Next, an example of generating the file of the apparatus configuration map 22 will be described.

FIGS. 13A and 13B are diagrams illustrating the process of creating the apparatus configuration map. Before creating the apparatus configuration map 22 of the apparatus B, a worker understands a memory map on the basis of the specification 21 of the apparatus B. In the example illustrated in FIGS. 13A and 13B, it is assumed that “read” is permitted but “write” is prohibited from 0x0 to 0x3FFF, “write” and “read” are permitted from 0x4000 to 0x1FFFF, and “read” is permitted but “write” is prohibited from 0x20000 to 0x3FFFF.

FIG. 13A illustrates an input screen of an assistant tool for generating the file of the apparatus configuration map. This assistant tool is implemented by a program that runs on a given OS using a general-purpose computer.

In the input example illustrated in FIG. 13A, a request to input the start address of the first address range of the memory map of the apparatus B (“Input start Address ->”) is displayed on the input screen. The worker inputs “0x00000000” as the start address of the first address range. Next, a request to input the end address and the access attribute (“Input end Address, w/r/wr ->”) is displayed on the input screen. The worker inputs “0x00003FFF, r” as the end address and the access attribute, respectively. In the example illustrated in FIG. 13A, the access attribute is input using “w” (write is permitted but read is prohibited), “r” (write is prohibited but read is permitted), or “wr” (write and read are permitted).

Thereafter, the start address, the end address, and the access attribute are inputted in the same manner. If input of information for each address range of the memory map of the apparatus B is completed, the worker inputs “end” on the screen that displays the request to input the start address, thereby completing the input operation to the assistant tool. After the completion of the input operation to the assistant tool, the assistant tool arranges the start address, the end address, the numerical value of the access attribute side by side on the basis of the input information so as to generate a file of an apparatus-configuration map 22A of the apparatus B illustrated in FIG. 13B. In the example of the apparatus configuration map 22A illustrated in FIG. 13B, each information is represented in hexadecimal notation in the order of the start address, the end address, and the numerical value representing the access attribute from the left on each line.

The input screen of the assistant tool and the specification regarding input of information are not limited to the example illustrated in FIG. 13A. Additionally, information may be manually input directly to the file of the apparatus configuration map 22A without using the assistant tool. Next, an example of creating the configuration-map constraint information file 35 by using the information of the page data and the apparatus-configuration map 22A created in the example illustrated in FIGS. 13A and 13B will be described. Here, it is assumed that the value of the page data is set to “0x1000” as in the example of FIG. 12B described above.

To generate the configuration-map constraint information file 35, each address range written in the apparatus configuration map 22A is divided by the value of the page data as illustrated in FIG. 8. The address range (0x00000000 to 0x00003FFF) on the first line in FIG. 13B is divided by the value of the page data (0x1000) into four address ranges. Start addresses of the four address ranges are then divided by the value of the page data, whereby four page IDs, i.e., 0x00000, 0x00001, 0x00002, and 0x00003, are obtained.

As described above, the page-access constraint information contained in the configuration-map constraint information file 35 is obtained by appending the access attribute information to the page ID information. Accordingly, the page-access constraint information for the address range written on the first line in FIG. 13B is obtained by appending the access attribute “0x1” to each of the four page IDs “0x00000”, “0x00001”, “0x00002”, and “0x00003”, and the resulting pieces of page-access constraint information are illustrated in FIG. 14. The page-access constraint information is generated for all address ranges written in the apparatus configuration map 22A illustrated in FIG. 13B in accordance with the procedure illustrated in FIG. 8 and the generated pieces of page-access constraint information are collected in one file, whereby the configuration-map constraint information file 35 is generated. The check process will be described next. After generation of the access address information file 33 and the configuration-map constraint information file 35A is completed, whether or not a memory access error would occur if the program 11 were executed on the apparatus B is checked on the basis of these files 33 and 35A.

FIG. 15 is a diagram illustrating an example of the check process. The checking unit 36 reads out the page access information, i.e., the page ID and the page access type, from the access address information file 33 (S105-11). As described above, the first page access information is “0x000013” according to the memory map specification of the apparatus A illustrated in FIG. 10.

The checking unit 36 then reads out the page-access constraint information (0x000011) that corresponds to the page ID (0x00001) read out from the access address information file 33, from the configuration-map constraint information file 35A (S105-12). At this time, when there is no page-access constraint information that corresponds to the page ID, for example, the page ID appended with the access attribute “0x0” can be used as the corresponding page-access constraint information. It is generally considered that the fact that there is no page-access constraint information that corresponds to the page ID indicates that an area corresponding to the page ID of the apparatus B is inaccessible. Accordingly, in this case, for example, the access attribute “0” can be set to indicate that neither “read” nor “write” is permitted.

Subsequently, the checking unit 36 checks whether or not the access type read out from the access address information file 33 contradicts the access attribute read out from the configuration-map constraint information file 35A (S105-13). Here, the access type included in the page access information (0x000013) read out for the first page ID from the access address information file 33 is “0x3”, whereas the access attribute included in the page-access constraint information (0x000011) that corresponds to this page ID (0x00001) is “0x1”.

In the access constraint, only “read” is permitted (0x1) for the page ID “0x00001”, whereas the program 11 performs “write-read (0x3)” for the page ID. Accordingly, the program 11 will cause access violation in an area having the page ID “0x00001”. Since access violation is detected in the check in S105-13, the process proceeds to S105-14.

In S105-14, the checking unit 36 reads out detailed information for the page ID “0x00001” from the access address information file 33. The checking unit 36 then checks, for each offset information of the read out detailed information, whether or not the access type contradicts the access attribute read out from the configuration-map constraint information file 35A. More specifically, as illustrated in FIG. 15, the checking unit 36 checks whether or not the access types (0x3, 0x1, and 0x2) of the detail information “0x0003, 0x0081, 0x0102” for the page ID “0x00001” contradict the access attribute (0x1). As a result, it is determined that the access types associated with the pieces of offset information “0x000” and “0x010” contradict the access attribute. The offset information and the access type for which it is determined that the access type contradicts the access attribute in the check performed in S105-14 are output as access violation information (S105-15). In S105-15, the access violation information may be displayed on the display device 57 by the result display unit 37 or may be output to a file that contains access violation information. Additionally, other information processing apparatuses may be informed of the access violation information found in S105-14 via a communication network.

Meanwhile, whether or not access violation would occur can be checked in S105-13 and S105-14 in the following manner. For example, (A) a result of logical multiplication (AND) of the access type included in the page access information and the access attribute included in the page-access constraint information is compared with (B) the access type included in the page access information. If (A) disagrees with (B), it can be determined that violation would occur.

If the unchecked page access information exists (YES in S105-16), the checking unit 36 sequentially reads out the page access information for the next page ID (S105-17) and performs the check in the same manner. If the unchecked page access information no longer exists (NO in S105-16), the check process ends.

As described above, the result of the simulation performed on the program that runs on the existing apparatus A and the memory map specification of the apparatus B that is being developed are treated as numerical information, whereby the page access information and the page-access constraint information are generated for each page. On the basis of the generated page access information and page-access constraint information, whether or not memory access violation will be caused by the program is checked in units of pages, whereby whether or not memory access violation will be caused by the program can be inspected at high speed. Accordingly, whether or not modification of the program is needed in order to make the program that runs on the existing apparatus A run on the apparatus B that is being developed can be determined in a short time.

### Third Embodiment

In another embodiment, information other than the access address information and the access type information may be included in the information that is outputted to the access-destination address list 13, for example. For example, a value of a program counter (PC value) indicated when the memory access is made, information indicating whether the memory access is instruction fetch or data access, and so forth can be outputted to the access-destination address list 13 together with the access type information. For each piece of offset information, the information output to the access-destination address list 13, such as the PC value, is stored together with the access type information as the detailed information in the access address information file 33.

The detailed information, such as the PC value, is not referred to in access check performed for each page access information. However, if access violation is detected (YES in S105-3 in FIG. 9), the detailed information, such as the PC value set at the time of occurrence of access violation, can also be read out from the access address information file 33 and displayed when the detailed information is displayed in S105-5 in FIG. 9. Since the detailed information, such as the PC value set at the time of occurrence of access violation, is displayed, the access violation error is more easily analyzed. While the present art has been described by using the embodiments, the present art can be variously modified within the scope of the gist of the present art and such modifications should not be excluded from the scope of the present art.

The present art is applicable to inspection of a program that runs on a computer.

With the solution, whether or not memory access violation would occur if a program that run on the existing apparatus A were executed on the apparatus B that is being developed can be inspected using a simple and efficient method.

As mentioned above, the present invention has been specifically described for better understanding of the embodiments thereof and the above description does not limit other aspects of the invention. Therefore, the present invention can be altered and modified in a variety of ways without departing from the gist and scope thereof.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiments of the present inventions have been described in detail, it should be understood that the various changes, substitutions, and alterations could be made hereto without departing from the spirit and scope of the invention.

What is claimed is:

1. A program inspection method for inspecting, by using a computer, whether or not a program that runs on an existing apparatus successfully runs on a target apparatus having a configuration that is different from a configuration of the existing apparatus, apparatus specifications of the target apparatus being already revealed, the program inspection method comprising:
generating an access address information file from an access-destination address list, the access-destination address list including addresses of access destinations accessed by the program and access types indicating whether write access or read access is made to the individual addresses by the program, the access address information file including, for each page representing a certain address range associated with the same access type, a page ID serving as identification information of the certain address range represented by the page and an access type of the page;
generating a configuration-map constraint information file that includes, for each of the pages into which a plurality of address ranges of memory areas of the target apparatus are divided, the plurality of address ranges being included in a memory map that includes access attributes indicating whether read access or write access is permitted in the individual memory areas of the target apparatus, a page ID serving as identification information of the certain address range represented by the page and a constraint represented by an access attribute of the page; and
inspecting, for each page ID, whether or not the access type for the page ID included in the access address information file contradicts the constraint represented by the access attribute for the page ID included in the configuration-map constraint information file.

2. The program inspection method according to claim 1,
wherein the generating the access address information file includes:
dividing a value of each of the addresses included in the access-destination address list by page data that is a value representing the size of the pages;
setting a quotient of the division as the page ID, and setting a remainder of the division as an offset address; and
generating page access information that includes the page ID and the access type for the page ID, and generating detailed information that includes the offset addresses for the page ID and the access types for the corresponding offset addresses,
wherein the inspecting includes inspecting, upon detection of access-attribute-constraint violation which indicates that an access type for a page ID included in the access address information file contradicts a constraint represented by an access attribute for the page ID included in the configuration-map constraint information file, whether or not access types for individual offset addresses included in detailed information for the page ID, for which the access-attribute-constraint violation has been detected, contradict the constraint represented by the access attribute for the page ID, and
wherein the program inspection method further comprises outputting, as an inspection result, the offset addresses for which the access-attribute-constraint violation has been detected in the inspection performed for the individual offset addresses, and the access types for the offset addresses.

3. The program inspection method according to claim 2,
wherein the generating the access address information file includes:
setting a result of logical addition of access types for a common page ID, as the access type of the page access information for the common page ID; and
including combinations of offset addresses for the common page ID and access types for the corresponding offset addresses in the detailed information for the common page ID.

4. The program inspection method according to claim 3,
wherein the addresses of the access destinations accessed by the program when the program is executed on a simulator that simulates operations of the existing apparatus, and the access types indicating whether write access or read access is made to the individual addresses by the program are output by using the simulator, so that the access-destination address list is created.

5. A non-transitory, computer readable storage medium storing an inspection program causing a computer to execute a process of inspecting whether or not a program that runs on an existing apparatus successfully runs on a target apparatus having a configuration that is different from a configuration of the existing apparatus, apparatus specifications of the target apparatus being already revealed, according to a process comprising:
generating an access address information file from an access-destination address list, the access-destination address list containing addresses of access destinations accessed by the program and access types indicating whether write access or read access is made to the individual addresses by the program, the access address information file containing, for each page representing a certain address range associated with the same access type, a page ID serving as identification information of the certain address range represented by the page and an access type of the page;
generating a configuration-map constraint information file that contains, for each of the pages into which a plurality of address ranges of memory areas of the target apparatus are divided, the plurality of address ranges being contained in a memory map that contains access attributes indicating whether read access or write access is permitted in the individual memory areas of the target apparatus, a page ID serving as identification information of the certain address range represented by the page and a constraint represented by an access attribute of the page; and
inspecting, for each page ID, whether or not the access type for the page ID contained in the access address information file contradicts the constraint represented by the access attribute for the page ID contained in the configuration-map constraint information file.

6. An apparatus for inspecting whether or not a program that runs on an existing apparatus successfully runs on a target apparatus having a configuration that is different from a configuration of the existing apparatus, apparatus specifications of the target apparatus being already revealed, the apparatus comprising:
a storage that stores an access-destination address list, the access-destination address list including addresses of access destinations accessed by the program and access types indicating whether write access or read access is made to the individual addresses by the program; and
a processor that generates an access address information file from the access-destination address list including addresses of access destinations accessed by the program and access types indicating whether write access or read access is made to the individual addresses by the program, the access address information file including, for each page representing a certain address range associated with the same access type, a page ID serving as identification information of the certain address range represented by the page and an access type of the page, generates a configuration-map constraint information file that includes, for each of the pages into which a plurality of address ranges of memory areas of the target apparatus are divided, the plurality of address ranges being included in a memory map that includes access attributes indicating whether read access or write access is permitted in the individual memory areas of the target apparatus, a page ID serving as identification information of the certain address range represented by the page and a constraint represented by an access attribute of the page, and inspects, for each page ID, whether or not the access type for the page ID included in the access address information file contradicts the constraint represented by the access attribute for the page ID included in the configuration-map constraint information file.
